(19) United States
(12) Patent Application Publication
(10) Pub. No.: US 2025/0180085 A1
(43) Pub. Date: Jun. 5, 2025

(54) WEAR INFORMATION CALCULATION SYSTEM, WEAR INFORMATION CALCULATION METHOD, AND STORAGE MEDIUM

(71) Applicant: KABUSHIKI KAISHA YASKAWA DENKI, Fukuoka (JP)

(72) Inventors: Nanami TOMURA, Fukuoka (JP); Isamu MATSUMURA, Fukuoka (JP); Toshinobu KIRA, Fukuoka (JP); Kazuya WATANABE, Fukuoka (JP); Jun KOJIMA, Fukuoka (JP); Takahisa YAMADA, Fukuoka (JP)

(21) Appl. No.: 18/961,831

(22) Filed: Nov. 27, 2024

(30) Foreign Application Priority Data
Dec. 1, 2023 (JP) 2023-204165

(51) Int. Cl. F16D 66/02; F16D 66/00

(52) U.S. Cl. CPC F16D 66/021; F16D 2066/003

(57) ABSTRACT

A wear information calculation system includes a movement control unit that moves a non-rotating body provided in a brake, between a displaced position where the non-rotating body comes into contact with a rotating body provided in the brake, thereby stopping rotation of the rotating body, and is displaced according to a wear state of at least one of the rotating body and the non-rotating body, and a predetermined fixed position where the non-rotating body is spaced apart from the rotating body, a vibration detection unit that detects vibration occurring when the non-rotating body reaches the fixed position, and a calculation unit that calculates the information on the wear state based on a measurement time from a measurement initiation timing based on a command to move the non-rotating body from the displaced position to the fixed position until the vibration detection unit detects the vibration.

### CROSS-REFERENCE TO RELATED APPLICATIONS

This application is based on and claims priority from Japanese Patent Application No. 2023-204165 filed on Dec. 1, 2023 with the Japan Patent Office, the disclosure of which is incorporated herein in its entirety by reference.

### TECHNICAL FIELD

The present disclosure relates to a wear information calculation system, a wear information calculation method, and a storage medium.

### BACKGROUND

Japanese Patent Laid-Open Publication No. 2019-002471 discloses a wear detection device that detects the wear of an electronic brake based on a brake release time. In the Publication, the brake release time refers to the time from the timing at which a brake control signal is detected to the timing at which a rotational angle detection value of a rotational angle sensor that detects the rotational angle of a motor varies, in a state where the motor is controlled to maintain the rotational angle by the weight of a member attached to a rotating shaft of the motor.

### SUMMARY

In the wear detection device of Japanese Patent Laid-Open Publication No. 2019-002471, a variation in the rotational angle of the motor due to the weight of the member attached to the rotating shaft may decrease according to the orientation of the rotating shaft, making it difficult to perform wear detection. Further, since wear detection is performed based on the instantaneous rotational operation during brake release, it is difficult to achieve stable and highly accurate detection.

The present disclosure provides a wear information calculation system, wear information calculation method, and a storage medium having stored therein a program capable of accurately calculating information on the wear state.

According to an aspect of the present disclosure, a wear information calculation system calculates information on a wear state of at least one of a rotating body and a non-rotating body included in a brake, and includes a movement control unit that moves the non-rotating body between a displaced position that is a position where the non-rotating body comes into contact with the rotating body, thereby stopping rotation of the rotating body, and is displaced according to the wear state and a predetermined fixed position where the non-rotating body is spaced apart from the rotating body, a vibration detection unit that detects vibration occurring when the non-rotating body reaches the fixed position, and a calculation unit that calculates the information on the wear state based on a measurement time from a measurement initiation timing based on a command to move the non-rotating body from the displaced position to the fixed position until the vibration detector detects the vibration.

According to the present disclosure, it is possible to accurately calculate information on the wear state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of a hardware configuration of a wear information calculation system.

FIG. 2A is a cross-sectional view schematically illustrating a motor and brake in a braking state.

FIG. 2B is a cross-sectional view schematically illustrating the motor and brake in a release state.

FIG. 3 is a diagram illustrating an example of functions implemented in the wear information calculation system.

FIG. 4 is a timing chart illustrating a measurement time.

FIG. 5 is a diagram illustrating how the measurement time varies according to the environmental temperature.

FIG. 6 is a flowchart illustrating a processing executed in the wear information calculation system.

FIG. 7 is a diagram schematically illustrating an example of a robot arm.

FIG. 8 is a diagram illustrating the measurement initiation timing in a modification.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

### [Overall Configuration of Wear Information Calculation System]

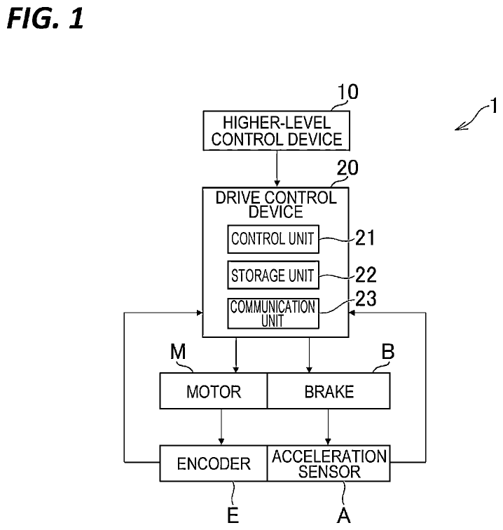

FIG. 1 is a diagram illustrating an example of a hardware configuration of a wear information calculation system. The wear information calculation system 1 is a system that calculates information on the wear state of a brake B. The wear information calculation system 1 includes a higher-level control device 10, a drive control device 20, a motor M, a brake B, an encoder E, and an acceleration sensor A. The hardware configuration illustrated in FIG. 1 is merely an example and is not a limitation, and the wear information calculation system 1 only needs to include at least one computer. Further, for example, the higher-level control device 10 and the drive control device 20 may each be composed of a plurality of computers. Further, although not illustrated, the wear information calculation system 1 may include a device that the user operates.

The higher-level control device 10 generates a motor command to control the operation of the motor M and sends it to the drive control device 20. Examples of the motor command may include a position command for controlling the rotational position of the motor M, a velocity command for controlling the angular velocity of the motor M, and a torque command for controlling the torque of the motor M. Further, the higher-level control device 10 generates a brake command to control the operation of the brake B and sends it to the drive control device 20. The higher-level control device 10 may be configured with, for example, a general-purpose personal computer, a Programmable Logic Controller (PLC), or a motion controller.

The drive control device 20 includes a controller unit 21, a storage unit 22, and a communication unit 23. The controller unit 21 includes at least one processor. The controller unit 21 executes a program stored in the storage unit 22 to control the driving of the motor M and brake B. The storage unit 22 includes at least one of a volatile memory and a non-volatile memory. The communication unit 23 includes at least one of a communication interface for wired communication and a communication interface for wireless communication.

The drive control device 20 supplies power to the motor M based on the motor command received from the higher-level control device 10 and rotational position information received from the encoder E, thereby controlling the driving of the motor M.

The drive control device 20 switches the supply of power to the brake B on or off based on the brake command received from the higher-level control device 10, thereby controlling the driving of the brake B.

The encoder E detects the rotational position information of the motor M and sends the rotational position information to the drive control device 20.

The acceleration sensor A detects information on vibrations in the brake B and sends the detected information to the drive control device 20. The acceleration sensor A may be installed, for example, on the encoder E. However, this is not a limitation, and the acceleration sensor A only needs to be installed at a position where it is capable of detecting the information on vibrations at least in the brake B. Further, the present embodiment describes the acceleration sensor A as an example, but is not limited to this, and any other sensor capable of detecting vibrations may be used as well.

The program stored in the drive control device 20 may be supplied via a network. Further, a hardware configuration of the drive control device 20 may employ various types of hardware and is not limited to the above-described example. For example, it may include a reader (e.g., a memory card slot) for reading a computer-readable information storage medium, or an input/output element (e.g., a USB terminal) for connection to an external device. In this case, a program stored in the information storage medium may be supplied through the reader or the input/output element.

### [Motor]

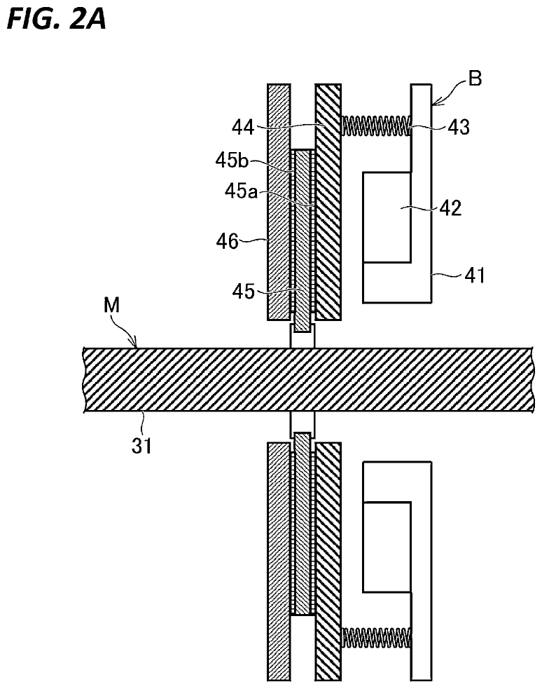

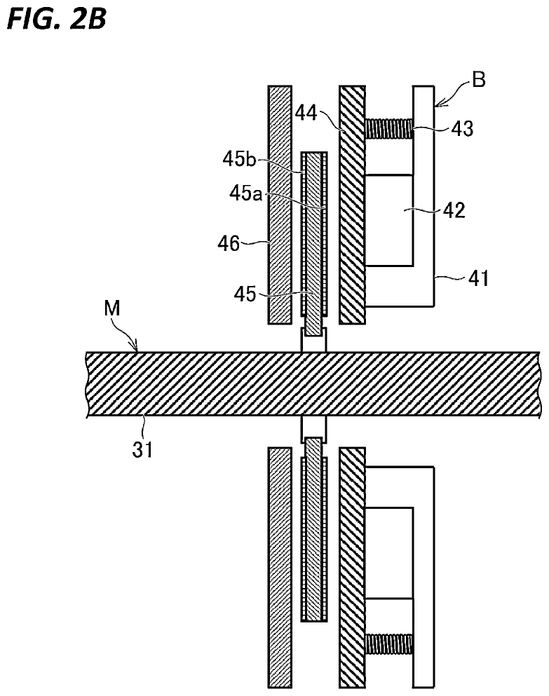

FIG. 2A is a cross-sectional view schematically illustrating a motor and brake in a braking state. FIG. 2B is a cross-sectional view schematically illustrating the motor and brake in a release state. The braking state refers to a state where the rotation of the motor M is braked by the brake B. The release state refers to a state where braking by the brake B is released, allowing the motor M to rotate. In FIGS. 2A and 2B, only a rotating shaft 31 of the motor M is illustrated, and the illustration of other parts is omitted.

The motor M may be, for example, a servo motor. In the present embodiment, an example is described in which the motor M is a brake-equipped motor that is integrally configured with the brake B. The motor M rotates around the rotating shaft 31 as the center of rotation. In the following description, the direction in which the rotating shaft 31 rotates is referred to as the rotational direction, and the direction in which the rotating shaft 31 extends is referred to as the axial direction.

### [Break]

The brake B may be, for example, an electronic brake. The brake B includes a field core 41, a brake coil 42, a pressure spring 43, an armature 44, a brake disc 45, and a side plate 46.

In the present embodiment, the brake B is a so-called non-excitation operable type brake. In other words, when the brake coil 42 is in a non-energized state, the rotation of the motor M is braked in the braking state (see e.g., FIG. 2A), and when the brake coil 42 is in an energized state, the motor M is rotatable in the release state (see e.g., FIG. 2B).

In the following description, the operation of the brake B that brakes the motor M is referred to as “brake operation,” and the operation of the brake B that releases the braking of the motor M is referred to as “brake release operation.” Further, a command from the higher-level control device 10 to perform the brake operation is referred to as “brake command,” and a command to perform the brake release operation is referred to as “brake release command.”

The field core 41 holds the brake coil 42 and the pressure spring 43. The field core 41 is fixed to a bracket or a similar device (not illustrated) so that it does not move in the rotational direction or the axial direction.

The brake coil 42 constitutes an electromagnet, along with a magnetic member arranged inside the brake coil 42. The brake coil 42 is electrically connected to the drive control device 20, and when receiving power supplied from the drive control device 20, it enters an energized state and generates a magnetic force that attracts the armature 44. In the energized state, the magnetic force with which the brake coil 42 attracts the armature 44 only needs to be greater than the force with which the pressure spring 43 elastically presses the armature 44. A plurality of brake coils 42 may be provided side by side in the rotational direction.

One end side of the pressure spring 43 is connected to the field core 41, and the other end side is connected to the armature 44. The pressure spring 43 elastically presses the armature 44 toward the field core 46 side. A plurality of pressure springs 43 may be provided side by side in the rotational direction.

The armature 44 is provided in such a way that it is not rotatable but is movable in the axial direction. The armature 44 may be moved in the axial direction by the pressure force of the pressure spring 43 and the magnetic force generated in the brake coil 42.

The side plate 46 is fixed to a bracket or a similar device (not illustrated) so that it does not move in the rotational direction or the axial direction.

The brake disc 45 is provided to be rotatable along with the rotating shaft 31 and to be movable in the axial direction. For example, the brake disc 45 may be attached to the rotating shaft 31 via a spline mechanism so as to allow the axial movement thereof relative to the rotating shaft 31.

A friction material is provided on a surface of the brake disc 45. The friction material is provided on both sides of the brake disc. Specifically, a friction material 45a is provided on a surface of the brake disc 45 toward the armature 44 side, and a friction material 45b is provided on a surface of the brake disc 45 toward the side plate 46 side. The brake disc 45 brakes the rotation of the motor M by friction generated between the armature 44 and the friction material 45a as well as friction generated between the side plate 46 and the friction material 45b.

As illustrated in FIG. 2A, the brake disc 45 is sandwiched between the armature 44 and the side plate 46 by the pressure force of the pressure spring 43 in the non-energized state of the brake coil 42, thereby braking the rotation of the motor M.

Meanwhile, as illustrated in FIG. 2B, the brake disc 45 is spaced apart from the armature 44 and the side plate 46 by a predetermined distance in the energized state of the brake coil 42, thereby allowing the rotation of the motor M.

As described above, among members included in the brake B, the brake disc 45 is rotatable along with the rotating shaft 31, while the other members do not rotate. Further, the armature 44 and the brake disc 45 are movable in the axial direction, while the other members do not move in the axial direction.

Here, the friction material 45a is worn by friction occurring between itself and the armature 44, and the friction material 45b is worn by friction occurring between itself and the side plate 46. If the wear of these friction materials increases, there is a risk of a malfunction in the brake B. This may prevent the proper braking of the rotation of the motor M.

Therefore, in the wear information calculation system 1 according to the present embodiment, a configuration is adopted to calculate the wear rate of the friction material in the brake B in order to determine whether the brake B is normal.

### [Functions Implemented in Wear Information Calculation System]

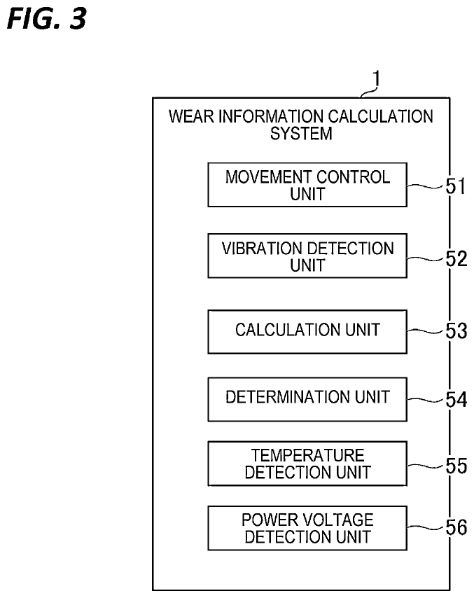

FIG. 3 is a diagram illustrating an example of functions implemented in the wear information calculation system 1. The wear information calculation system 1 includes a movement control unit 51, a vibration detection unit 52, a calculation unit 53, a determination unit 54, a temperature detection unit 55, and a power supply voltage detection unit 56. The movement control unit 51, calculation unit 53, determination unit 54, and power supply voltage detection unit 56 may be implemented by the controller unit 21 provided in the drive control device 20. The vibration detection unit 52 may be implemented by the control unit 21 provided in the drive control device 20 and the acceleration sensor A. The temperature detection unit 55 may be implemented by the controller unit 21 provided in the drive control device 20 and a temperature sensor (not illustrated). However, this is not a limitation, and each of these functions may also be implemented by other computers included in the wear information calculation system 1.

The movement control unit 51 moves the armature 44 between a displaced position and a fixed position. Specifically, the movement control unit 51 moves the armature 44 from the displaced position to the fixed position by switching the brake coil 42 from the non-energized state to the energized state. Further, the movement control unit 51 moves the armature 44 from the fixed position to the displaced position by switching the brake coil 42 from the energized state to the non-energized state.

The displaced position refers to the position of the armature 44 that comes into contact with the brake disc 45 to stop the rotation of the brake disc 45. This displaced position depends on the wear state of the brake B. The fixed position refers to the position of the armature 44 that is spaced apart from the brake disc 45. This fixed position remains constant regardless of the wear state of the brake B. For example, when the friction materials 45a and 45b are worn, the displaced position is closer to the side plate 46. In other words, the distance between the displaced position and the fixed position increases, and the time until the armature 44 moves from the displaced position to the fixed position also increases. FIG. 2A illustrates a state where the armature 44 is at the displaced position, while FIG. 2B illustrates a state where the armature 44 is at the fixed position.

The vibration detection unit 52 detects vibrations that occur when the armature 44 reaches the fixed position based on a detection value from the acceleration sensor A.

Here, when the brake release operation is executed, the armature 44 moves from the displaced position to the fixed position. The armature 44 collides with the brake coil 42 upon reaching the fixed position. Vibrations occurring at this time are detected by the vibration detection unit 52.

The acceleration sensor A only needs to detect acceleration in the axial direction and in two-axes orthogonal to the axial direction (a total of three-axes). Then, when a composite value obtained by combining detection values in these three-axes becomes a predetermined threshold or more, the vibration detection unit 52 detects vibrations. By performing vibration detection based on the composite value in this way, the accuracy of vibration detection may be improved compared to vibration detection based only on a single-axis detection value. However, this is not a limitation, and the vibration detection unit 52 may also detect acceleration only, for example, in the axial direction (the direction in which the armature 44 moves).

The calculation unit 53 calculates a wear rate W, which is information on the wear state, based on a measurement time T from a measurement initiation timing based on a command to move the armature 44 from the displaced position to the fixed position until the vibration detection unit 52 detects vibrations.

In the present embodiment, the wear rate W is defined as a ratio of, to the difference between a predetermined longest time (first time) T_{Max} until the vibration detection unit 52 detects vibrations when the wear state is a limit state (first state) and a predetermined shortest time (second time) T_{Min} until the vibration detection unit 52 detects vibrations when the wear state is an initial state (second state), the difference between the measurement time T and the predetermined shortest time T_{Min}. Specifically, the wear rate W is represented by the following equation (1). The initial state or the second state refers to, for example, the state of the brake B where the friction materials 45a and 45b are unused and no wear has occurred. The limit state or the first state refers to, for example, the state where the wear of the friction materials 45a and 45b has reached a level where further wear may potentially cause a malfunction in the brake B. However, this is not a limitation, and it is at least sufficient that the second state has less wear than the first state and that the second time is shorter than the first time.

$$\begin{matrix}Equation 1 & \\ W = \frac{T - {T}_{min}}{{T}_{max} - {T}_{min}} \times 100 & ( 1 )\end{matrix}$$

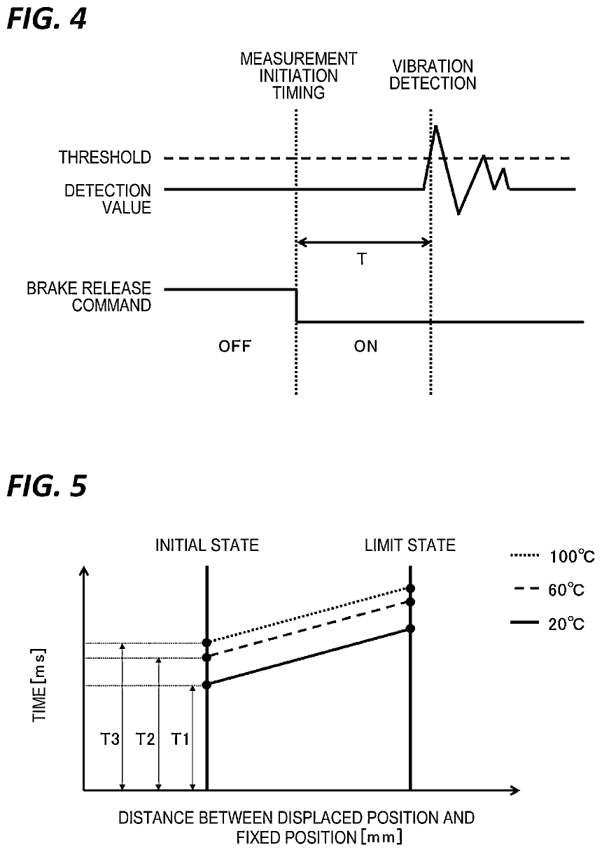

Here, the measurement time T is defined as the time from the measurement initiation timing until the detection value from the acceleration sensor A becomes a predetermined threshold or more. FIG. 4 illustrates an example in which the detection value from the acceleration sensor A becomes a predetermined threshold or more when T seconds have passed from the measurement initiation timing. By using a predetermined threshold as a reference for vibration detection in this way, it is possible to prevent erroneous detection of small vibrations other than those occurring when the armature 44 reaches the fixed position.

The measurement initiation timing may be the timing at which the brake release command is sent from the higher-level control device 10. Alternatively, considering the lag between when the brake release command is sent and when the drive control device 20 receives the brake release command, the timing at which a predetermined time has passed from the timing at which the brake release command is sent may be used as the measurement initiation timing. Alternatively, considering the lag between when the drive control device 20 receives the brake release command and when the brake B initiates the brake release operation, the timing at which a predetermined time has passed from the timing at which the brake release command is sent may be used as the measurement initiation timing.

The determination unit 54 determines whether the brake B is normal based on the wear rate. For example, the determination unit 54 may determine that the brake B is not normal if the wear rate is a predetermined rate or higher. The wear information calculation system 1 may be configured to issue an alert to the user if the determination unit 54 determines that the brake B is not normal. This allows the user to be prompted to repair the brake B or replace parts of the brake B.

The determination unit 54 may not be necessary, and may be configured to simply notify the user of the wear rate W calculated by the calculation unit 53. Then, the user may judge whether the brake B is normal based on the wear rate W.

The temperature detection unit 55 detects the environmental temperature around the brake coil 42, for example, based on a detection value from the temperature sensor. The temperature sensor only needs to be positioned where it is capable of detecting at least the temperature around the brake coil 42.

Here, as illustrated in FIG. 5, the measurement time T may vary according to the environmental temperature around the brake B. The horizontal axis in FIG. 5 represents the distance between the displaced position and the fixed position, while the vertical axis represents time.

FIG. 5 illustrates that the higher the environmental temperature around the brake B, the longer the measurement time T. Specifically, in the initial state, the measurement time T is T1 when the environmental temperature is 20° C., the measurement time T is T2 (>T1) when the environmental temperature is 60° C., and the measurement time T is T3 (>T2) when the environmental temperature is 100° C.

The measurement time T varies according to the environmental temperature because the resistance of the brake coil 42 varies due to the influence of temperature. For example, when the environmental temperature is high, the resistance of the brake coil 42 increases, thereby reducing the amount of current flowing through the brake coil 42, which results in a longer measurement time T. Therefore, it is advisable to correct the equation (1) used for the calculation of the wear rate W based on the environmental temperature detected by the temperature detection unit 55. For example, the calculation unit 53 may either add a predetermined correction value according to the environmental temperature to the longest time T_{Max} and the shortest time T_{Min} or multiply them by a predetermined correction coefficient before calculating the wear rate W using the equation (1).

The power supply voltage detection unit 56 detects a power supply voltage that drives the brake B. Even with the same environmental temperature, the measurement time T varies according to the power supply voltage. For example, a higher power supply voltage increases the amount of current supplied to the brake B, which increases the movement speed of the armature 44. As the movement speed of the amateur 44 increases, the measurement time T becomes shorter. Therefore, it is advisable to correct the equation (1) used for the calculation of the wear rate W based on the power supply voltage detected by the power supply voltage detection unit 56. For example, the calculation unit 53 may either add a predetermined correction value according to the power supply voltage to the longest time T_{Max} and the shortest time T_{Min} or multiply them by a predetermined correction coefficient before calculating the wear rate W using the equation (1).

### [Flowchart]

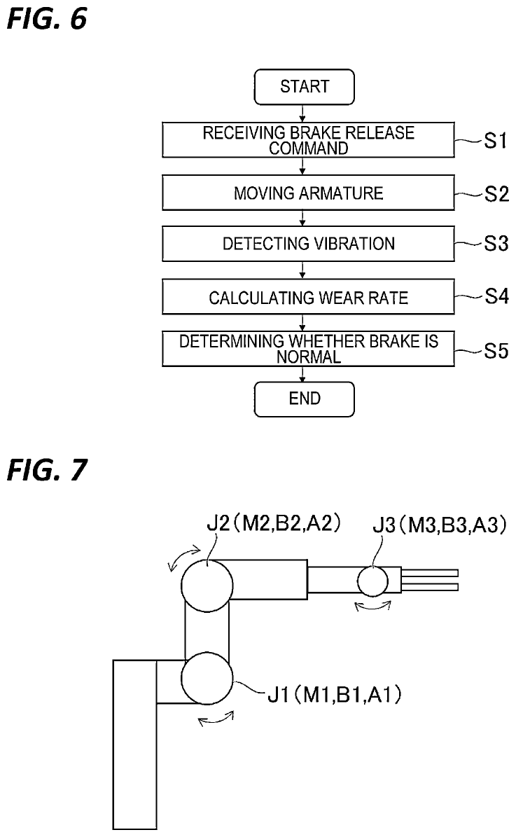

Next, an example of processing executed in the wear information calculation system 1 will be described with reference to FIG. 6. FIG. 6 is a flowchart illustrating the processing executed in the wear information calculation system. In FIG. 6, the processing executed by the drive control device 20, among the processing executed in the wear information calculation system 1, is illustrated. The processing illustrated in FIG. 6 is executed by the control unit 21 executing a control program stored in the storage unit 22. The processing illustrated in FIG. 6 is an example of processing executed by the functional blocks illustrated in FIG. 3.

First, the drive control device 20 receives a brake release command from the higher-level control device 10 (S1). Then, the movement control unit 51 moves the armature 44 from the displaced position to the fixed position based on the brake release command (S2).

Next, the vibration detection unit 52 detects vibrations based on the detection value from the acceleration sensor A (S3). Furthermore, the calculation unit 53 calculates the wear rate based on the measurement time from the measurement initiation timing to the detection of vibrations (S4). The calculation of the wear rate by the calculation unit 53 may be performed using correction values according to the environmental temperature and power supply voltage as described above.

After that, the determination unit 54 determines whether the brake B is normal based on the wear rate calculated by the calculation unit 53 (S5).

In the wear information calculation system 1 according to the present embodiment described above, by calculating information on the wear state through the detection of vibrations caused by the brake release operation, it is possible to accurately calculate the wear state information regardless of the rotation amount of the motor M. Further, it is possible to accurately calculate the wear state information while preventing the influence of the environmental temperature and power supply voltage.

### Modification

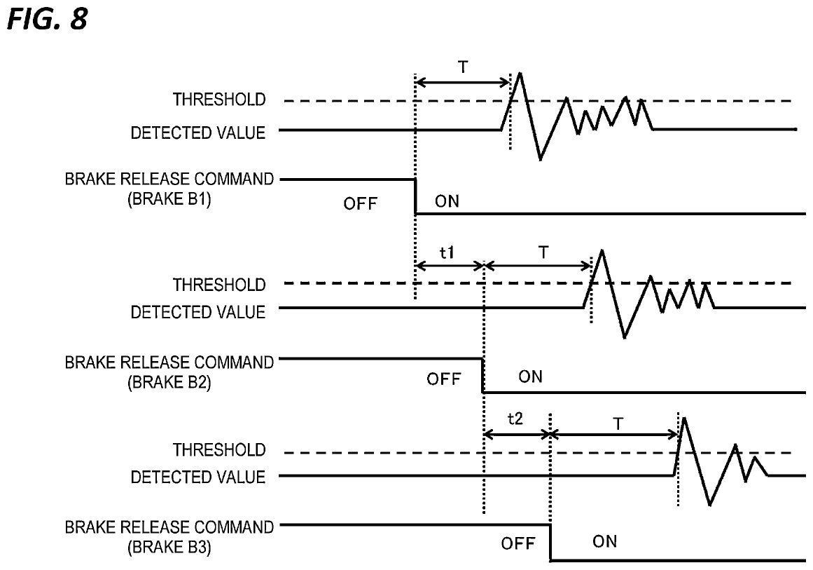

A modification of the wear information calculation system will be described with reference to FIGS. 7 and 8. FIG. 7 is a diagram schematically illustrating an example of a robot arm. FIG. 8 is a diagram illustrating the measurement initiation timing in a modification.

In a mechanism illustrated in FIG. 7, the robot arm has three joints, and each joint is provided with the motor M, the brake B, and the acceleration sensor A. Specifically, a first joint J1 is provided with a motor M1, a brake B1, and an acceleration sensor A1, a second joint J2 adjacent to the first joint M1 is provided with a motor M2, a brake B2, and an acceleration sensor A2, and a third joint J3 adjacent to the second joint J2 is provided with a motor M3, a brake B3, and an acceleration sensor A3. The motors M1 to M3 and brakes B1 to B3 are all operated in response to commands from the higher-level control device 10.

Here, when brake release commands are issued simultaneously or at close timing to the brakes B1 to B3 from the higher-level control device 10, the acceleration sensors A1 to A3 may detect vibrations at close timing for these brakes B1 to B3. This may lead a risk that, for example, vibrations caused by the brake disc 45 reaching the brake coil 42 in the brake B1 are erroneously detected by the acceleration sensor A2 corresponding to the brake B2. Thus, it might not be possible to properly acquire the measurement time for each brake, potentially adversely affecting the proper calculation of the wear rate.

Therefore, in the modification, as illustrated in FIG. 8, the timing for receiving the brake release command from the higher-level control device 10 is made different for each of the brakes B1 to B3. This ensures that the timing for initiating the brake release operation is made different for each of the brakes B1 to B3. Specifically, FIG. 8 illustrates an example in which the brake B2 receives the brake release command after a time t1 has passed from the timing at which the brake B1 received the brake release command, and the brake B3 receives the brake release command after a time t2 has passed from the timing at which the brake B2 received the brake release command. This helps to prevent the erroneous detection of vibrations as described above.

The timing for initiating the brake release operation in each of the brakes B1 to B3 may be made different by staggering the timing at which the brake release command is sent from the higher-level control device 10. Alternatively, the time between receiving the brake release command and initiating the brake release operation may be made different for each of the brakes B1 to B3.

Further, the initiation timing of the brake release operation at least in the brakes B provided in the adjacent joints may be made different. This is because erroneous detection is more likely to occur at the adjacent joints. For this reason, for example, it is beneficial to differentiate the initiation timing of the brake release operation at least in the brake B2 provided at the joint J2 from those of the brakes B1 and B3 provided at the joints J1 and J3.

Although FIG. 7 illustrates the robot arm with three joints J1 to J3, this is not a limitation, and any mechanism with at least two joints may be used. Further, the rotational direction of the motor provided at each joint is not limited to the direction depicted by the arrows in the drawing. Further, the motor M is not limited to that driving the joint, and at least two motors M, along with the brakes B and acceleration sensors A corresponding thereto, may be provided in a common mechanism.

### Other Modifications

While the present embodiment has described an example in which the friction material is provided on the brake disc 45 that is a rotating body, this is not a limitation, and the friction material may also be provided on a surface of a non-rotating body such as the armature 44. That is, the wear information calculation system 1 may also be used to calculate information on the wear state of a non-rotating body.

Further, in the present embodiment, a so-called double-sided brake in which the friction material is provided on both sides of the brake disc 45 has been illustrated, but this is not a limitation, and a so-called single-sided brake in which the friction material is provided on only one side of the brake disc 45 may also be used.

Further, the present embodiment has described a non-excitation operable type brake that brakes the motor M in a non-energized state, but this is not a limitation, and an excitation operable type brake that brakes the motor M in an energized state may also be used.

### APPENDICES

For example, the wear information calculation system 1 may also be configured as follows.
(1) A wear information calculation system that calculates information on a wear state of at least one of a rotating body and a non-rotating body included in a brake, the system including:
a movement control unit that moves the non-rotating body between a displaced position where the non-rotating body comes into contact with the rotating body, thereby stopping rotation of the rotating body, and is displaced according to the wear state, and a predetermined fixed position where the non-rotating body is spaced apart from the rotating body;
a vibration detection unit that detects vibration occurring when the non-rotating body reaches the fixed position; and
a calculation unit that calculates the information on the wear state based on a measurement time from a measurement initiation timing based on a command to move the non-rotating body from the displaced position to the fixed position until the vibration detection unit detects the vibration.
(2) The wear information calculation system according to (1), in which the measurement time is a time from the measurement initiation timing until a detection value by the vibration detection unit becomes a predetermined threshold or more.
(3) The wear information calculation system according to (1) or (2), in which the calculation unit calculates, as the information on the wear state, a wear rate that is a ratio of a difference between the measurement time and a second time to a difference between a first time and the second time, the first time being a time until the vibration is detected when the wear state is a first state, and the second time being a time until the vibration is detected when the wear state is a second state with less wear than the first state.
(4) The wear information calculation system according to (3), in which the first time is a time until the vibration is detected when the wear state is a limit state, and the second time is a time until the vibration is detected when the wear state is an initial state.
(5) The wear information calculation system according to (3) or (4), in which the brake includes a brake coil,
the movement control unit moves the non-rotating body between the displaced position and the fixed position by controlling an energization state of the brake coil, and
the calculation unit calculates the wear rate based on the predetermined first time and second time.
(6) The wear information calculation system according to (5), further including a temperature detection unit that detects a temperature at least around the brake coil,
in which, the calculation unit acquires the first time and the second time according to the temperature and calculates the wear rate based on the acquired first time and second time.
(7) The wear information calculation system according to any one of (3) to (6), in which the calculation unit acquires the first time and the second time according to a power supply voltage of the brake and calculates the wear rate based on the acquired first time and second time.
(8) The wear information calculation system according to any one of (1) to (7), further including a determination unit that determines whether the brake is normal based on the information on the wear state.
(9) The wear information calculation system according to any one of (1) to (8), further including an acceleration sensor,
in which the vibration detection unit detects the vibration based on a detection value from the acceleration sensor at least in a direction in which the non-rotating body moves.
(10) The wear information calculation system according to any one of (1) to (9), wherein the brake includes a first brake and a second brake provided in a common mechanism, and
in which the calculation unit calculates the information on the wear state of the first brake and the second brake respectively under a condition where a timing to initiate movement of the non-rotating body included in the first brake from the displaced position to the fixed position is different from a timing to initiate movement of the non-rotating body included in the second brake from the displaced position to the fixed position.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A wear information calculation system comprising:
movement control circuitry configured to move a non-rotating body provided in a brake, between a displaced position where the non-rotating body comes into contact with a rotating body provided in the brake, thereby stopping rotation of the rotating body, and is displaced according to a wear state of at least one of the rotating body and the non-rotating body, and a predetermined fixed position where the non-rotating body is spaced apart from the rotating body;
vibration detection circuitry configured to detect vibration occurring when the non-rotating body reaches the fixed position; and
calculation circuitry configured to calculate information on the wear state based on a measurement time from a measurement initiation timing based on a command to move the non-rotating body from the displaced position to the fixed position until the vibration detection circuitry detects the vibration.

2. The wear information calculation system according to claim 1, wherein the measurement time is a time from the measurement initiation timing until a detection value by the vibration detection circuitry becomes a predetermined threshold or more.

3. The wear information calculation system according to claim 1, wherein the calculation circuitry calculate, as the information on the wear state, a wear rate that is a ratio of a difference between the measurement time and a second time to a difference between a first time and the second time, the first time being a time until the vibration is detected when the wear state is a first state, and the second time being a time until the vibration is detected when the wear state is a second state with less wear than the first state.

4. The wear information calculation system according to claim 3, wherein the first time is a time until the vibration is detected when the wear state is a limit state, and
the second time is a time until the vibration is detected when the wear state is an initial state.

5. The wear information calculation system according to claim 3, wherein the brake includes a brake coil,
the movement control circuitry move the non-rotating body between the displaced position and the fixed position by controlling an energization state of the brake coil, and
the calculation circuitry calculate the wear rate based on the first time and second time set in advance.

6. The wear information calculation system according to claim 5, further comprising:
temperature detection circuitry configured to detect a temperature at least around the brake coil,
wherein the calculation circuitry acquire the first time and the second time according to the temperature and calculates the wear rate based on the acquired first time and second time.

7. The wear information calculation system according to claim 3, wherein the calculation circuitry acquire the first time and the second time according to a power supply voltage of the brake and calculate the wear rate based on the acquired first time and second time.

8. The wear information calculation system according to claim 1, further comprising:
determination circuitry configured to determine whether the brake is normal based on the information on the wear state.

9. The wear information calculation system according to claim 1, further comprising an acceleration sensor,
wherein the vibration detection circuitry detect the vibration based on a detection value from the acceleration sensor at least in a direction in which the non-rotating body moves.

10. The wear information calculation system according to claim 1, wherein the brake includes a first brake and a second brake provided in a common mechanism, and
wherein the calculation circuitry calculate the information on the wear state of the first brake and the second brake, respectively, under a condition where a timing to initiate movement of the non-rotating body included in the first brake from the displaced position to the fixed position is different from a timing to initiate movement of the non-rotating body included in the second brake from the displaced position to the fixed position.

11. A wear information calculation method comprising:
moving a non-rotating body provided in a brake, between a displaced position where the non-rotating body comes into contact with a rotating body provide in the brake, thereby stopping rotation of the rotating body, and is displaced according to a wear state of at least one of the rotating body and the non-rotating body, and a predetermined fixed position where the non-rotating body is spaced apart from the rotating body;
detecting vibration occurring when the non-rotating body reaches the fixed position; and
calculating information on the wear state based on a measurement time from a measurement initiation timing based on a command to move the non-rotating body from the displaced position to the fixed position until the vibration is detected.

12. A non-transitory computer-readable storage medium having stored therein a program that causes a computer to function as:
movement control circuitry configured to move a non-rotating body provided in a brake, between a displaced position where the non-rotating body comes into contact with a rotating body, thereby stopping rotation of the rotating body, and is displaced according to the wear state, and a predetermined fixed position where the non-rotating body is spaced apart from the rotating body;
vibration detection circuitry configured to detect vibration occurring when the non-rotating body reaches the fixed position; and
calculation circuitry configured to calculate the information on the wear state based on a measurement time from a measurement initiation timing based on a command to move the non-rotating body from the displaced position to the fixed position until the vibration is detected.
